(19) United States
(12) Patent Application Publication
(10) Pub. No.: US 2026/0270203 A1
(43) Pub. Date: Sep. 10, 2026

(54) Handling of Busyness Indications by a Node of an Integrated-Circuit Data Processing Apparatus

(71) Applicant: Arm Limited, Cambridge (GB)

(72) Inventors: Cesar Aaron Ramirez, Austin, TX (US); Koustav Bhattacharya, Austin, TX (US); Dimitrios Kaseridis, Austin, TX (US); Ashok Kumar Tummala, Cedar Park, TX (US); Jamshed Jalal, Austin, TX (US); Randall John Pascarella, Round Rock, TX (US)

(73) Assignee: Arm Limited, Cambridge (GB)

(21) Appl. No.: 19/086,283

(22) Filed: Mar. 21, 2025

(30) Foreign Application Priority Data
Mar. 5, 2025 (EP) 25300011.1

(51) Int. Cl. H04L 47/12; H04L 47/2408

(52) U.S. Cl. CPC H04L 47/12; H04L 47/2408

(57) ABSTRACT

A data processing network comprises an integrated-circuit data processing apparatus and at least one external device, external to the apparatus. The integrated-circuit data processing apparatus comprises an interconnect system, at least one target device coupled to the interconnect system, and a requesting node, coupled to the interconnect system. The requesting node is configured to receive requests from the at least one external device, and output the requests to a target device of the at least one target device via the interconnect system, thereby acting as a bridge for the at least one external device. The requesting node is configured to receive at least one busyness indication from at least one of the target devices, and, based on the received busyness indication(s), to throttle its outputting of requests received from the at least one external device to at least one of the at least one target devices via the interconnect system.

### TECHNICAL FIELD

The present invention relates to a data processing network and a method of data processing.

### BACKGROUND OF THE INVENTION

It is known generally for nodes in a data processing network to send busyness indications (for example, in CHI “Completer Busy” indications sometimes referred to as “Cbusy” values) back to requestors, in order for the requestors to modify their behaviour in light of these busyness values, e.g. to output fewer requests to particularly busy devices or types of devices. These busyness indications are sent back to requestors in response to requests received from the requestors.

In the case of requestors (e.g. requesting nodes) which act as bridging devices to external (e.g. input-output) devices, it is desirable that such external devices also respond to busyness indications, however handling of busyness indications may be challenging since passing busyness indications received by the bridging device back to the external (e.g. input-output) devices in order for those devices to modify their behaviour introduces a significant delay, and different devices may be configured to modify their behaviours differently to each other (or even not at all) which may introduce imbalances in the network, and since the method of configuring these devices may be different to how other devices in the network are configured, this may make the overall configuring of the system more challenging.

Similarly, for (resource) nodes which provide bridging devices to external (e.g. input-output) devices acting as completers (i.e. receivers of requests), handling of busyness indications presents a challenge. For example, it would cause a delay if such bridging devices wait to receive busyness indications from their downstream external devices in order to generate their own (i.e. overview) busyness value, and such a busyness value may be out of date already by the time it is generated.

The present inventions seek to address these shortcomings.

### SUMMARY OF THE INVENTION

According to a first aspect of the present invention, there is provided a data processing network comprising an integrated-circuit data processing apparatus; and at least one external device, external to the integrated-circuit data processing apparatus. The integrated-circuit data processing apparatus comprises an interconnect system, at least one target device, the at least one target device coupled to the interconnect system, and a requesting node, coupled to the interconnect system. The requesting node is configured to receive requests from the at least one external device, and output the requests to a target device of the at least one target device via the interconnect system, thereby acting as a bridge for the at least one external device. The requesting node is configured to receive at least one busyness indication from at least one of the target devices, and, based on the received busyness indication(s), to throttle its outputting of requests received from the at least one external device to at least one of the at least one target devices via the interconnect system.

According to a second aspect of the present invention, there is provided a method of data processing, comprising:

receiving, by a requesting node of an integrated-circuit data processing apparatus of a data processing network, requests from at least one external device, external to the integrated-circuit data processing apparatus, directed towards at least one target device coupled to an interconnect system;

outputting the requests to the target devices, thereby acting as a bridge for the at least one external device;

in response to the requests, receiving, by the requesting node, responses, the responses comprising at least one busyness indication from at least one of the target devices; and

based on the received busyness indication(s), the requesting node throttling its outputting of requests received from the at least one external device to at least one of the at least one target devices via the interconnect system.

According to a third aspect of the present invention, there is provided a data processing network comprising an integrated-circuit data processing apparatus, and at least one downstream resource, external to the integrated-circuit data processing apparatus. The integrated-circuit data processing apparatus comprises an interconnect system, at least one requesting node and a resource node, associated with the at least one downstream resource and coupled to the at least one requesting node via the interconnect system. The resource node is configured to receive requests from a requesting node via the interconnect system directed towards the at least one downstream resource, thereby acting as a bridge for the at least one downstream resource. The resource node comprises a buffer, for storing outstanding requests awaiting response from the at least one downstream resource. The resource node is configured to generate at least one busyness indication responsive to a request from a requesting node, the busyness indication based on a number of storage elements occupied in the buffer of the resource node.

### BRIEF DESCRIPTION OF THE DRAWINGS

FIG. 1 is a schematic diagram showing an integrated circuit data processing system to which the invention may be applied;

FIG. 2 is a flow diagram representing a method according to an embodiment of the present invention which may be carried out by certain nodes of the integrated circuit data processing system of FIG. 1;

FIG. 3 is a flow diagram representing an exemplary method which may form part of the method of FIG. 2;

FIG. 4 is a schematic diagram representing certain nodes of the integrated circuit data processing system of FIG. 1; and

FIG. 5 is a flow diagram representing a method according to a further embodiment of the present invention.

### DETAILED DESCRIPTION

From a first aspect, the invention provides a data processing network comprising:

an integrated-circuit data processing apparatus; and

at least one external device, external to the integrated-circuit data processing apparatus;

the integrated-circuit data processing apparatus comprising:

an interconnect system;

at least one target device, the at least one target device coupled to the interconnect system; and

a requesting node, coupled to the interconnect system, the requesting node configured to receive requests from the at least one external device, and output the requests to a target device of the at least one target device via the interconnect system, thereby acting as a bridge for the at least one external device;

wherein the requesting node is configured to receive at least one busyness indication from at least one of the target devices, and, based on the received busyness indication(s), to throttle its outputting of requests received from the at least one external device to at least one of the at least one target devices via the interconnect system.

According to a second aspect of the present invention there is provided a method of data processing, comprising:

receiving, by a requesting node of an integrated-circuit data processing apparatus of a data processing network, requests from at least one external device external to the integrated-circuit data processing apparatus, directed towards at least one target device coupled to an interconnect system;

outputting the requests to the target devices, thereby acting as a bridge for the at least one external device;

in response to the requests, receiving, by the requesting node, responses, the responses comprising at least one busyness indication from at least one of the target devices; and

based on the received busyness indication(s), the requesting node throttling its outputting of requests received from the at least one external device to at least one of the at least one target devices via the interconnect system.

Thus it will be seen that, in accordance with the invention, by a requesting node throttling its request outputs to the interconnect system based on busyness indications which it receives (i.e. in response to requests it issues), the requesting node itself is able to adjust its behaviour based on the busyness of the target devices to which it issues requests, thus preventing the target devices from becoming overwhelmed. This adaptation is achieved without needing to pass received busyness indications on to the external devices coupled to the node, and wait for them to each throttle their outputting of requests back to the node in response. The present method thereby achieves a change in behaviour responsive to a change in busyness level much quicker than relying on the external devices themselves to throttle, and it also achieves a fairer and more uniform throttling throughout the data processing network since the requesting nodes may be configured to throttle their behaviour in a similar manner to other nodes in the network which are not coupled to external devices (whereas external devices may each throttle their behaviour differently to each other and other nodes, or not at all).

The requesting node acts as a bridge for the at least one (optionally a plurality of) external device(s). By this it is meant that it provides a bridging device which forms a connection between the external device(s) and the interconnect system, passing requests from the external device(s) onto the interconnect system, and ultimately on to their target devices, i.e. acting as a bridge to the devices located behind it. A single requesting node may act as a bridge for one or more than one external device(s). The throttling behaviour may be particularly beneficial in the case of the node acting as a bridge for several devices since the requesting node may be able to throttle more fairly across the different external devices for which it acts as a bridge (i.e. than if each throttles individually).

The external device(s) may be understood as traffic requestors inbound to the bridge (i.e. the requesting node). The external device(s) may be input-output device(s).

The network may comprise more than one requesting node (i.e. a plurality), each acting as a bridge for one or more respective external device(s), i.e. the network may comprise a second (i.e. set of) at least one external devices, and a second requesting node acting as a bridge for the second at least one external device(s).

A request will be understood as a type or category of transaction which may be transmitted on the interconnect system, i.e. to trigger an action in response to receipt of the transaction.

The network comprises at least one target device. It may optionally comprise a plurality of target devices, each coupled to the interconnect system. A target device will be understood as a transaction completing device, i.e. any device to which a transaction may be sent by the requesting node and which will in response provide a busyness indication (e.g. in addition to or as part of some form of response). For example, a target device may comprise a home node (e.g. HNF, HNI), a subordinate node (SNF) or a chip-to-chip gateway device (CCG) as discussed in further detail below.

The requesting node is configured to throttle its outputting of requests to the target device(s) via the interconnect system based on the received busyness indication(s). By this it will be understood that the requesting node acts to suppress, restrain or limit its outputting of requests, by any suitable means. This may be achieved, for example, by limiting the allowed of outstanding (unfulfilled) requests it has made to the interconnect system to below a (configurable) limit, as explained further below.

The busyness indication may be any suitable signal which provides an indication of a busyness of a target device, e.g. a returned busyness value. The busyness indication may have one of two values, i.e. have two possible values, i.e. indicating either busy or not busy, or it may have more than two possible values, optionally four possible values, indicating a level of busyness with greater granularity. The busyness indication may be received by the requesting node in response to requests it issues to target devices (i.e. passes on from respective external devices). The busyness indication may form part of the response(s) received in reply to the request, i.e. as part of the reply, or be separate to but associated with the reply.

In some embodiments, the requesting node is configured to throttle its outputting of write requests and read requests independently. Thus busyness levels in relation to read and write transactions may be considered separately, meaning on some occasions the requesting node may throttle down its outputting of read requests, but continue to output write transactions at a higher rate, or vice versa. This is advantageous since there may be very different demands for each type of requests, and a very different outstanding number of each, and this therefore prevents one type of transaction being negatively impacted by busyness affecting only the other type. This is furthermore advantageous because the external devices may be connected to the requesting node by a connection (e.g. bridge) which handles read and write transactions separately (e.g. AXI bridge).

In some embodiments, the data processing network comprises at least one target device of a first type, and at least one target device of a second type, and the requesting node is configured to throttle its outputting of requests to target devices of the first type and the second type independently (i.e. of each other). Thus, the requesting node may be configured to throttle its outputting of requests based on the target type of the request, i.e. the target device which the request is directed towards. Thus, on some occasions the requesting node may reduce its outputting of requests to a first type of device (e.g. internal, on-chip devices), whilst maintaining a higher (optionally maximum) outputting of requests to a second type of device (e.g. off-chip, remote devices). This is particularly advantageous since there is a high degree of variability in the type of devices which external devices may target (e.g. compared to other types of device which may target only one, local memory type), and it is therefore beneficial to throttle requests to some different types independently.

An example of the different types are local (i.e. on-chip, within the integrated-circuit data processing apparatus) devices and remote (i.e. off-chip, external to the integrated-circuit data processing apparatus) devices. Thus, in some embodiments the first type is local, on-chip target devices and the second type is remote, off-chip target devices. This is advantageous since requests to remote devices usually already have a longer round-trip time than requests to local devices, and it is therefore preferable to throttle transactions to those less aggressively to avoid further delaying an already slower process.

In some embodiments, the first type is a peer external device, and the second type is a memory device (e.g. dynamic random-access memory (DRAM), optionally an HNF). A peer external device will be understood as a request directed to a target device which is another external (e.g. input-output) device.

In some embodiments, the data processing network comprises at least one external device of a first type, and at least one external device of a second type, wherein the requesting node is configured to throttle its outputting of requests received from external devices of the first type and the second type independently. Thus, the requesting node may be configured to throttle its outputting of requests based on source type of the request. This is beneficial since the requesting node may act as a bridge for more than one type of external device, which may have different requirements (e.g. Quality of Service levels) and this allows the throttling to be better adapted for each different type.

In some embodiments, the first type are external devices having a first quality of service class and the second type are external devices having a second quality of service class, the second quality of service class being different to the first quality of service class. Throttling requests issued by each of the different types independently helps the requirements of these different quality of service classes to be achieved. External devices having different quality of service classes may be configured to output different quality of service priority values (QPVs) with its output requests.

The type of an external device may also reference the identity of a particular device or a group of devices. Thus, where the type relates to the identity of the device each device may effectively be considered as its own type.

In some embodiments the first type of external device is a device associated with a first device identifier, and the second type of external device is a device associated with a second device identifier. The device identifiers may be a port identifier, representing the port through which the external device is coupled to the requesting node, or the device identifiers may be device-specific identifiers, e.g. source IDs of the devices. It will be appreciated that if only one external device is coupled through each port of the requesting node, then the port identifiers may effectively provide device-specific identifiers.

Similarly, in some embodiments the method comprises the requesting node throttling its outputting of requests based on at least one of the type of the target device for the request and/or the type of the external device issuing the request.

In some embodiments, the requesting node is configured to limit its number of outstanding requests to at least one of the target device(s) to an outstanding-request-threshold, and wherein the requesting node is configured to vary the outstanding-request-threshold based on the received busyness indication(s). This provides a means to throttle the outgoing requests which is straightforward to implement.

Outstanding requests will be understood as requests which the requesting node has output to the interconnect system and for which a response has not yet been received. These may be stored in a buffer of the requesting node (i.e. until they are completed).

There may be a single outstanding-request-threshold for all requests (i.e. for requests to all of the target devices, an overall total for outstanding requests), or alternatively there could be at least two outstanding-request-thresholds, each relating to a subset of outstanding request types (e.g. for requests of different types, such as target device types or requesting external device types).

Thus, in some embodiments, the outstanding-request-threshold is a first outstanding-request-threshold, associated with a first request type, the requesting node further configured to limit its number of outstanding requests of a second request type to a second outstanding-request-threshold, the value of the first outstanding-request-threshold being independent of the value of the second outstanding-request-threshold. The referenced types of request may be any of the types referenced above, e.g. read vs write requests, requests distinguished by source type, requests distinguished by target type etc.

In some embodiments, the received busyness indication(s) may be indicative of one of at least a first busyness level and a second busyness level, wherein the requesting node is configured to compare the number of first level busyness indications received in a sampling window to a first threshold, and if the number of first level busyness indications received in the sampling window exceeds the first threshold, to decrement the outstanding-request-threshold by a decrement value. Thus if more than a threshold amount of high busyness responses are received in a particular sampling window, the allowed number of outstanding requests is reduced, thereby throttling the outputting of requests.

In some embodiments the requesting node is further configured to generate an overview busyness indication, based on the overview busyness indication indicating a low level of busyness, incrementing the outstanding-request-threshold by an increment value. Thus, provided that the busyness level is determined to be low, the allowed number of outstanding requests is increased.

Incrementing the outstanding-request-threshold (or determining the overview busyness indication) may be conditional on the number of first level busyness indications received in the sampling window being below the first threshold. Thus, the amount of outstanding requests allowed may only be increased if there’s not an indication of at least some components having a high busyness value.

In some embodiments, generating an overview busyness indication may comprise (or consist of) comparing the number of second level busyness indications received in the sampling window to a second threshold. The busyness indication may include at least one (optionally two or more) intermediate (third) levels (e.g. indicating moderate busyness). In some embodiments, generating an overview busyness indication may comprise (or consist of) comparing the number of third (intermediate) level busyness indications received in the sampling window to a third threshold.

The first, second and/or third thresholds may be the same or different.

In some embodiments, the increment value is different to the decrement value (i.e. they are different to each other, having different magnitudes or values). The increment value may be lower than the decrement value. This allows the outputting of requests to be throttled more aggressively and stepped back up more slowly. The increment value and/or the decrement value may be static or may be variable, e.g. based on the received busyness indications. This allows them to be better adapted to a given situation. For example, the increment and/or decrement value may be chosen from several (e.g. respective) pre-set values of different sizes based on received busyness indications or comparison of these to various thresholds.

In some embodiments, the first threshold, the second threshold, the increment value, the decrement value and a magnitude of the sampling window are configurable (e.g. at setup of the data processing network). In some embodiments, the (described) busyness indication functionality may be selectively activatable (i.e. able to be enabled and disabled) for a given data processing apparatus (node), e.g. by being enabled by a control bit.

It will be understood that where multiple outstanding-request-thresholds are used, the requesting node may comprise duplicates of the parameters referenced above (e.g. the first threshold, the second threshold, the increment value, the decrement value and a magnitude of the sampling window are configurable) and any or all of these may have different values associated with the respective request types.

In some embodiments, the requesting node is configured to filter the busyness indications received from the at least one target device such that the number of busyness indications counted in response to a particular request is limited to a maximum of one. In some networks, certain types of request may prompt more than one reply in response, e.g. both a reply on a response channel and a reply on a data channel, or two read responses, each of which will include an associated busyness indication. By filtering the received busyness indications, this avoids such transactions (which trigger multiple replies, each with respective busyness indications), from unfairly biasing the overall busyness level which the requesting node interprets to be present based on the received indications. Furthermore, some external devices (i.e. requestors) may (even if possibly connected to only a single port of the bridging requesting node) have multiple (e.g. CHI) interfaces onto the interconnect system. This may be necessitated, for example, by bandwidth requirements of the external requestor. As a result, a particular request from that external device would be issued across both of these interfaces to the interconnect system, and therefore responses would likewise be received on both interfaces, each containing corresponding busyness indications. It will be appreciated that the filtering may likewise filter such busyness indications, received in response to a single request but across multiple interfaces to the interconnect system, so that only one busyness indication is counted overall for a single request. The filtering by the requesting node may be achieved based on an identifier of the particular request, and/or based on a number of responses extended for the type of the particular request (e.g. it knows to expect two replies and to count only one of the received busyness indications, e.g. the completion response).

In some embodiments, the requesting node may further be configured to pass the busyness indications it receives in response to a request back to the external device which issued the request. This may allow the external devices to also adapt their behaviour (e.g. throttle their outputting of requests) based on the busyness indications, further helping not to overwhelm busy devices (or types of device).

From a third aspect, the invention provides a data processing network comprising:

an integrated-circuit data processing apparatus; and

at least one downstream resource, external to the integrated-circuit data processing apparatus;

the integrated-circuit data processing apparatus comprising:

an interconnect system;

at least one requesting node;

a resource node (e.g. an HNI or CCG), associated with the at least one downstream resource (e.g. an IO device or another integrated-circuit data processing apparatus) and coupled to the at least one requesting node (e.g. an RNF/RNI/RND) via the interconnect system, wherein the resource node is configured to receive requests from a requesting node via the interconnect system directed towards the at least one downstream resource, thereby acting as a bridge for the at least one downstream resource; and

the resource node comprising a buffer, for storing outstanding requests awaiting response from the at least one downstream resource, wherein the resource node is configured to generate at least one busyness indication responsive to a request from a requesting node, the busyness indication based on a number of storage elements occupied in the buffer of the resource node.

From a fourth aspect of the present invention, there is provided a method of data processing, comprising:

receiving, by a resource node of an integrated-circuit data processing apparatus of a data processing network, requests from a requesting node via an interconnect system coupled between the requesting node and the resource node, the requests directed towards at least one downstream resource, the resource node thereby acting as a bridge for the at least one downstream resource;

storing, in a buffer of the resource node, outstanding requests awaiting response from the at least one downstream resource;

receiving, by the resource node, a request; and

responsive to receiving the request, generating by the resource node at least one busyness indication, the busyness indication based on a number of storage elements occupied in the buffer of the resource node.

By the resource node generating its own busyness value based on a number of storage elements available in the buffer (e.g. the “main” buffer) of the request node the resource node is able to provide a useful indication of its busyness promptly, rather than contacting its associated downstream resource(s), receiving busyness indications from them, and generating an (overview or average) busyness indication based on the received responses. This allows the network to behave more responsively to changes in busyness of the external downstream resource(s).

It will be understood that the number of occupied storage elements refers to the number of entries which are unavailable at a particular time in relation to the particular request (e.g. upon receipt of the request by the resource node or at issuance of the reply to the request). An entry may be considered as occupied if it stores a pending request, but optionally also if it reserved for an anticipated incoming request, even if this is not yet stored, since such an entry will be unavailable. Thus occupied storage elements may comprise elements storing entries and optionally also elements reserved for entries. Thus, this may also be considered as the busyness indication being based on a number of entries in the buffer available.

The resource node acts as a bridge for the at least one (optionally a plurality of) downstream resource(s). By this it is meant that it provides a bridging device which forms a connection between the interconnect system and the downstream resource(s), passing requests from requesting nodes, issued on the interconnect system, to the downstream resource(s). A single resource node may act as a bridge for one or more than one downstream resource(s). The busyness indication generating behaviour may be particularly beneficial in such a case since the resource node may be able to straightforwardly produce a signal which is indicative of an overall, or average, busyness across the various downstream resource(s).

The network comprises at least one downstream resource. It may optionally comprise a plurality of downstream resources (e.g. coupled to the same or different resource nodes). A downstream device will be understood as a device, external to the integrated circuit data processing apparatus, able to receive and complete requests. It may for example be an external, off-chip memory, or a second integrated-circuit data processing apparatus. The resource node may thus be understood as a node able to provide a bridging device for such downstream resource(s) – e.g. an input-output home node (e.g. HNI, or variants HND, HNT, HNV), or a chip-to-chip gateway device (CCG).

In some embodiments, the resource node comprises a first buffer, associated with downstream resources of a first type, and a second buffer associated with downstream resources of a second, different type, and the resource node is configured to generate a busyness indication in response to a request directed to a downstream resource of the first type based on a number of storage elements occupied in the first buffer (e.g. upon receipt of the request by the resource node or at issuance of the reply to the request). The resource node may further be configured to generate a busyness indication in response to a request directed to a downstream resource of the second type based on a number of storage elements occupied in the second buffer (e.g. upon receipt of the request by the resource node or at issuance of the reply to the request).

Thus, the resource node may maintain separate buffers associated with different types of downstream resource, and may monitor the busyness of these buffers separately, and thereby output different busyness values depending on the type of downstream resource which a particular request is directed towards. Thus, in response to a particular request, the resource node may output only the relevant busyness indication, i.e. based on the type of resource that the request is directed to, such that two different requests received by the resource node at effectively the same time might receive different busyness indications from the resource node in response, if the requests are directed to different types of downstream resource.

The type of a downstream resource may relate to a certain category, e.g. off-chip memory vs integrated circuit apparatus, or a memory type, or may relate to the identity of the device, e.g. one buffer per downstream resource.

In some embodiments, the resource node comprises or is configured in connection with a system address map, wherein the resource node uses the system address map to identify the type of resource to which a request is directed (i.e. so that it can return the appropriate busyness indication based on this).

Concepts described herein may be embodied in computer-readable code for fabrication of an apparatus that embodies the described concepts. Thus, according to fifth and sixth aspects of the present invention, there is provided a non-transitory computer-readable medium storing computer-readable code for fabrication of the data processing network described herein above according to the first and third aspects of the invention, respectively. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Features of any aspect or embodiment described herein may, wherever appropriate, be applied to any other aspect or embodiment described herein. Where reference is made to different embodiments or sets of embodiments, it should be understood that these are not necessarily distinct but may overlap. It will furthermore be understood that references made to a method comprising a step correspondingly extend to a module “configured to” carry out a step, and vice versa.

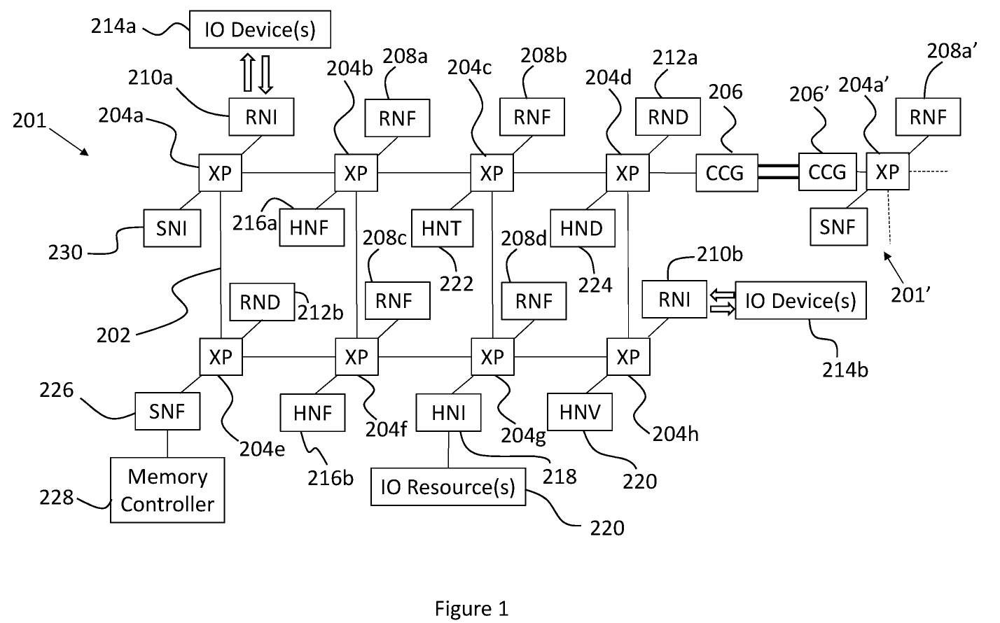

FIG. 1 is a schematic illustration of an integrated circuit data processing system 201 for processing requests. The integrated circuit data processing system 201 includes a plurality of nodes, described in further detail below. As explained below, one or more of these nodes may provide a data processing apparatus as claimed, such that the integrated circuit data processing system 201 of FIG. 1 may embody the claimed invention.

The nodes are coupled together by an interconnect 202, thus forming a connection between the functional blocks which the nodes provide. The interconnect 202 provides signal connections between the nodes and may have various topologies. For example, the interconnect 202 may be configured to form a mesh network, a ring network, a cross-bar network, or other network. The interconnect may provide a number of cross-points (XPs) 204a-204h. Each cross-point 204a-204h provides one more device ports for coupling to nodes (e.g. to request nodes and home nodes as described below) and one or more interconnect ports which couple to other cross-points. Where the interconnect 202 forms a mesh network, the integrated circuit data processing system 201 may be referred to as a (coherent) mesh network 201.

Transmissions throughout the interconnect 202 are able to be sent on four channels provided by the interconnect 202 – these are referred to as a Request Channel (REQ), a Response Channel (RESP), a Data Channel (DAT), and a Snoop Channel (SNP). Each of these (or only some, e.g. RESP and DAT) may be duplicated in order to provide separate channels for transmit (TX) and receive (RX). The REQ channel is used for sending read and write requests, cache maintenance requests, and DVM requests. The RESP channel is used to send completion responses for various types of messages, ranging from write and cache management responses to data-less snoop responses and operation completion acknowledgments. The SNP channel issues snoops and sends DVM operations. The DAT channel is used to send write and read data, and snoop responses which include data.

All protocol messages are sent in the form of a Flit. Flits are a packetized collection of control fields and identifiers that communicate a protocol message.

Some of the control fields sent in a Flit include opcodes, memory attributes, address, data, and error responses. Each channel needs different Flit control fields. For example, a Flit to read or write on the Request channel needs an Address field, and a Flit on the Data channel needs the Data and Byte Enable fields. The fields in a Flit may be sent in parallel (i.e. not serialized over multiple packets).

Chip-to-chip gateways (CCGs) couple between the network on one chip (i.e. one integrated circuit data processing system 201) and a network on another chip (i.e. a second integrated circuit data processing system 201’). This enables formation of a network spanning multiple chips. Two example chip-to-chip gateways 206, 206’ belonging respectively to the first and second integrated circuit data processing systems 201, 201’ are shown in FIG. 1, coupling an XP 204d of the first integrated circuit data processing system 1 to an XP 204a’ of a second integrated circuit data processing system 201’. Only a small part of the second integrated circuit data processing system 201’ is shown, as illustrated by the use of dashed lines out from the XP 204a’.

In this example, CCG nodes 206, 206’ include both a request agent (RA), for issuing requests and receiving snoops, and a home agent (HA), for receiving requests and issuing snoops.

There are three categories of node which may be present in the integrated circuit data processing system 201 – these are Request Nodes (RNs), Home Nodes (HNs) and subordinate nodes (SNs). Each of these is described further below.

The role of request nodes is to generate transactions, such as read and write requests, in order to access and process data. These transactions are sent to Home Nodes (HNs).

There are several different varieties of request node, each of which is described by a corresponding term - a Fully Coherent Request Node (RNF), an input/output (I/O) Coherent Request Node (RNI), and an I/O Coherent RN with Distributed Virtual Memory (DVM) support (RND). A request node may be, for example, a central processing unit (CPU) core, a neural engine or other accelerator, or a Component Aggregation Layer that houses two or more CPU cores to be connected to one network port.

A Fully Coherent Request Node (RNF) contains coherent caches and will accept and respond to snoop messages for accessing or changing the coherency state of cached data. It will be understood that coherency refers to ensuring that all processors in the system see the same view of memory, meaning that changes to data held in the cache of one core are visible to the other cores, making it impossible for cores to see stale copies of data (the old data from before it was changed by the first core).

An I/O-Coherent Request Node (RNI) does not have a coherent cache, and cannot accept snoop messages. An I/O-Coherent Request Node with DVM support (RND) has the same functionality as an RNI and can also accept DVM messages. Example RNFs 208a-208d, 208a’, RNIs 210a, 210b, and RNDs 212a, 212b, are illustrated in the integrated circuit data processing system 201 of FIG. 1. As illustrated, the RNIs are connected to one or more IO devices 214a, 214b. Although not illustrated, it will be understood that the RNDs 212a, 212b, may also be connected to one or more IO devices.

Home Nodes (HNs) receive transactions from Request Nodes (RNs), and are responsible for ordering these requests, generating transactions to SNs (discussed below) and in some cases issuing snoops and handling DVM operations.

There are two main types of home node – fully coherent Home Nodes (HNFs), which order all requests to coherent memory and issue snoops to RN-Fs, and non-coherent Home Nodes (HNIs) which order requests that target an I/O subsystem. Both types act as a point of serialization.

The integrated circuit data processing system 201 includes a system level cache (SLC) which may reduce the number of accesses to memory and reduce the latency of data accesses. The system level cache may be distributed across a large set of home nodes in a network to share the cache capacity over all network nodes across multiple chips, in particular across the fully coherent home nodes (HNFs). The portion of a system level cache (SLC) present at a particular HNF may be referred to as a system cache group (SCG). A fully coherent home node (HNF) provides a point of coherency for a subset of system addresses and provides a cache for storing data associated with the addresses. Coherency may be provided by a snoop filter (SF) that tracks data copied to caches in the network caches. HNFs may thus comprise a system cache group (part of the system level cache) and a snoop filter. Thus, HNFs control coherency among data stored by the data processing system. Two example HNFs 216a, 216b are shown in FIG. 1. FIG. 1 also shown an example HNI 218, which is coupled to one or more I/O resources 220.

There are then further types of home node which are variations of the HNIs which have additional functionality compared to an HNI – these include HNVs, HNTs, and HNDs. An HNV is an HNI which further includes a distributed virtual memory (DVM) node. An HNT is an HN-I further including the functionality of both a DVM node and also a Debug Trace Controller (DTC). An HN-D is HN-I further including the functionality of a DVM node, a DTC, and a configuration subordinate (which is a subordinate interface for configuration register space access). FIG. 1 shows an example of each of an HNV 220, HNT 222 and HND 224.

A distributed virtual memory (DVM) node, also referred to as a DN, controls its own respective DVM domain, such that each RNF sends its DVM requests to the DN in its own domain. DVM requests are messages which request a DVM operation in order to support maintenance of the virtual memory system. The DN propagates snoops and receives corresponding responses, based on the received DVM request. As described above, DVM nodes may be present within various different types of node.

Subordinate nodes (SNs) provide access to data sources and sinks, such as memory and peripheral devices. A memory or peripheral device may be located off-chip or on-chip (i.e. as part of the integrated circuit data processing system 201, or separate from it).

There are two types of subordinate node - fully coherent subordinate nodes (SNFs) which connect to memory devices that back the coherent memory space, and non-coherent subordinate nodes (SNIs) which connect to I/O peripherals or non-coherent memory. FIG. 1 shows an example SNF 226, connected to a memory controller 228, and it shows an example SNI 230, which as explained may be connected to non-coherent memory or an I/O peripheral (not shown).

Every component in the system is assigned a Unique Node ID. The system may then use a System Address Map (SAM) to convert physical addresses to a Node ID.

To be able to determine the target Node ID of outgoing requests, each RN and HN has a corresponding system address map.

It is useful generally for Home Nodes in the network 201 to send busyness indications (sometimes referred to as “Cbusy” values) back to requestors, in order for the requestors to modify their behaviour in light of these busyness values, e.g. to output fewer requests to particularly busy devices or types of devices. These busyness indications are sent back to requestors in response to requests received from the requestors, i.e. together with the reply (or replies) to the particular request, such as the response on a response channel, or a data reply. This is straightforward in the case of RNFs, but may be more difficult to achieve in the case of external (e.g. input-output) devices 214a, 214b, which are connected to the interconnect system 202 by bridging devices (RNIs 210a, 210b). The present invention seeks to address this.

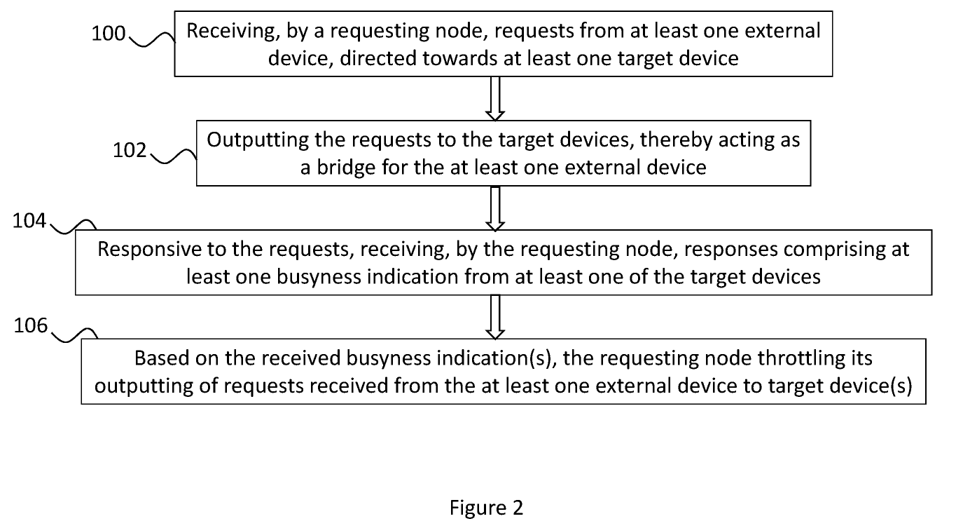

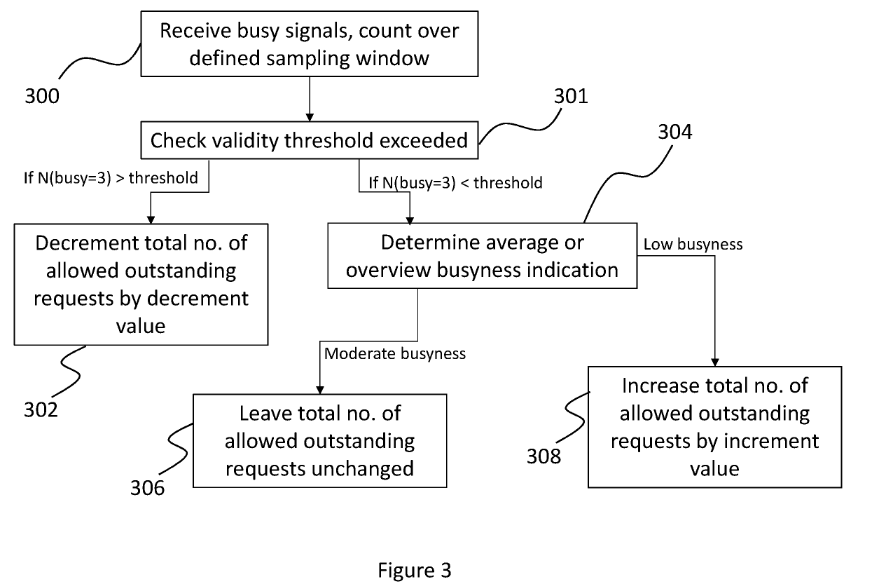

Thus, according to the present invention, the RNIs 210a, 210b are able to modify their outputting of requests to the interconnect system 202 based on busyness indications which they receive, as described with reference to the flow diagram of FIGS. 2 and 3. According to the present example, the busyness indication sent back by a home node has one of four values – these may be referred to as busyness values of 0 (not busy), 1 (low busy), 2 (medium busy) and 3 (very busy).

Generally, the method comprises the steps of receiving, by a requesting node of an integrated-circuit data processing apparatus of a data processing network, requests from at least one external device external to the integrated-circuit data processing apparatus, directed towards at least one target device coupled to an interconnect system (step 100); outputting the requests to the target devices, thereby acting as a bridge for the at least one external device (step 102); in response to the requests, receiving, by the requesting node, responses, the responses comprising at least one busyness indication from at least one of the target devices (step 104); and based on the received busyness indication(s), the requesting node throttling its outputting of requests received from the at least one external device to at least one of the at least one target devices via the interconnect system (step 106).

According to the present example, the requesting node (RNI) 210a, 210b, counts the number of each busyness value which is received across a sampling window (i.e. in response to requests issued in that sampling window). This is represented at step 300 in FIG. 3. The sampling window may be defined as a total number of busyness indications (e.g. for 100 responses total, how many are of each type) or it may be defined as a time window.

At step 301, it is first checked that the total number of busyness indications received in the sampling window meets or exceeds a threshold number of busyness indications for a valid determination of busyness to be determined. This threshold amount may be referred to as a “Validity Threshold”. If this condition is not met, the method begins again at step 300, collecting a different set of samples. Otherwise, the method proceeds as explained below.

It will be appreciated that there are many suitable ways in which the busyness values received in a given time window may be taken into account to determine an appropriate behaviour for the requesting node, and that the below simply demonstrates one possible example method.

In this example, the number of highest-level “very busy” responses (value 3) received in the sampling window is compared with a threshold. If the number of very busy values received in the sampling window exceeds the threshold, the method proceeds to step 302, otherwise it proceeds to step 304, as shown in FIG. 3.

At step 302, a total number of requests which the requesting node is permitted to have outstanding on the interconnect system (which may be referred to as the “Outstanding Requests Limit” of the requesting node) is decreased, by an amount defined by a “decrement value”. Thus the requesting node lowers the total number of outstanding requests it allows itself to have on the interconnect system, thereby throttling its outputting of requests onto the interconnect system.

The decrement value may be pre-set, or may be variable (e.g. dependent on the busyness indications which are received).

Alternatively, if the received “very busy” values are not higher than the threshold, the method proceeds to step 304 at which an average or overview busyness indication is determined by any suitable method. This may be, for example, by comparing the number of medium busy values received in the sampling window to a (second) threshold (which may be different to or the same as the other threshold), and/or by comparing the number of 1 or 0 busyness values received to a third (same or different) threshold. These, may respectively (or together) indicate either a moderate busyness value, which causes the method to proceed to step 306, or a low busyness value, causing the method to proceed to step 308.

If the network is determined to be moderately busy, then at step 306, the Outstanding Requests Limit is kept unchanged. Alternatively, if the network is determined to have low busyness, then the Outstanding Requests Limit is increased by an amount defined by an “increment value”.

Again, the increment value may be pre-set, or may be variable (e.g. dependent on the busyness indications which are received). It may be different to the decrement value. In particular, the decrement value may be larger than the increment value, this causes the outputting of requests to be throttled relatively aggressively when the network becomes busier, but then allows the outputting of requests to be increased more gradually as the system becomes less busy again, to prevent overwhelming the system all over again.

In this example, the size of the sampling window, the increment value, the decrement value, the first threshold, the second threshold, the third threshold and the Validity Threshold are configurable, e.g. at set-up.

The requesting node may comprise a buffer comprising storage elements for storing outstanding requests. In order to minimize rejected requests, the requesting node may be configured to deallocate certain storage elements when the Outstanding Requests Limit is reduced, but it may be configured to still allocate these storage elements to store entries corresponding to new incoming requests, but not to actually dispatch these requests until some outstanding requests are completed. Thus the number of outstanding requests is reduced, throttling the outputting of requests, but the storage capacity of the requesting node for incoming requests is still used.

A requesting node may carry out the method of FIGS. 2 and/or 3 collectively for all requests, but alternatively it may duplicate this method separately for different types of requests, e.g. for read vs write requests, for different source types and/or target types etc. as explained above. Thus, the requesting node may maintain separate buffers for these different types of request and/or maintain different counts for busy values received from target devices in response to requests of these different types.

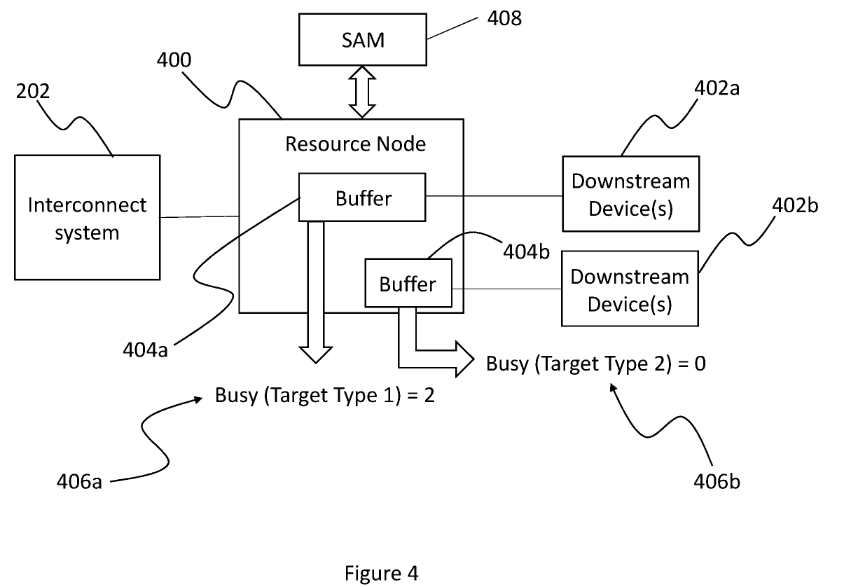

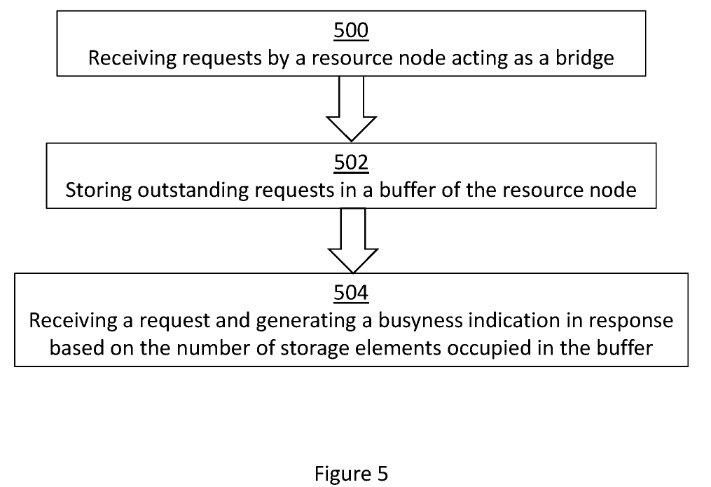

FIG. 4 is a schematic diagram representing operation which may be carried out by the HNIs 218, variant HNIs (HNV 220, HNT 222, HND 224) nodes, and CCGs 206, 206’ of the integrated circuit data processing system of FIG. 1, which provide bridging devices to components external to the integrated-circuit data processing apparatus 201. These may be referred to more generally as a resource node 400 (i.e. which may be any of these node types). FIG. 5 is a flow diagram representing the method carried out by the node(s) represented in FIG. 4.

The resource node 400 is associated with a first one or more downstream resource(s) of a first type 402a and a second one or more downstream resource(s) of a second type 402b, external to the integrated circuit data processing apparatus, and each coupled to the requesting nodes (e.g. RNF/RNI/RNDs) seen in FIG. 1 via the interconnect system 202 which it is connected to. The downstream resource(s) 402a, 402b may be, for example an external IO resource 220 (i.e. for an HNI resource node) or a second integrated circuit data processing network 201’ (i.e. for a CCG 206).

The resource node 400 is configured to receive requests from requesting nodes via the interconnect system 202 directed towards the downstream resources 402a, 402b, thereby acting as a bridge for the downstream resources 402a, 402b.

In this particular example, the resource node 400 comprises a first buffer 404a, associated with downstream resource(s) 402a of a first type, and a second buffer 404b associated with downstream resource(s) 402b of a second, different type. The buffers may be referred to as point of coherency queues. A Point of Coherence (PoC) may be understood as a point at which all agents that can access memory are guaranteed to see the same copy of a memory location. For example, an HN-F may be a point of coherency.

The buffers 404a, 404b store outstanding requests awaiting response respectively from the first type of downstream resource(s) 402a and the second type of downstream resource(s) 402b.

The resource node 400 is configured to generate at least one busyness indication 406a, 406b responsive to a request from a requesting node (via the interconnect system 202), the busyness indication 406a, 406b is based on a number of storage elements occupied in the relevant buffer 404a, 404b of the resource node 400. In particular, the resource node 400 is configured to generate a first busyness indication 406a in response to a request directed to a downstream resource of the first type 402a based on a number of storage elements occupied in the first buffer 404a and to generate a second busyness indication 406b in response to a request directed to a downstream resource of the second type 402b based on a number of storage elements occupied in the second buffer 404b.

Thus, the resource node 400 maintains separate buffers associated with different types of downstream resource 402a, 402b, and monitors the busyness of these buffers separately, and thereby outputs different busyness values depending on the type of downstream resource 402a, 402b which a particular request is directed towards. Thus, in response to a particular request, the resource node 400 may output only the relevant busyness indication 406a, 406b, i.e. based on the type of resource that the request is directed to, such that two different requests received by the resource node at approximately the same time might receive different busyness indications from the resource node in response, if the requests are directed to different types of downstream resource.

The resource node 400 is connected to a system address map 408. The resource node 400 uses the system address map 408 to identify the type of resource to which a request is directed i.e. so that it can return the appropriate busyness indication 406a, 406b based on this.

FIG. 5 illustrates the method of operation of the resource node 400. The method comprises the following steps:

First, in a step 500, receiving, by a resource node of an integrated-circuit data processing apparatus of a data processing network, requests from a requesting node via an interconnect system coupled between the requesting node and the resource node, the requests directed towards at least one downstream resource, the resource node thereby acting as a bridge for the at least one downstream resource.

Next, at step 502, storing, in a buffer of the resource node, outstanding requests awaiting response from the at least one downstream resource.

At a step 504, receiving, by the resource node, a request, i.e. a particular request, and responsive to receiving the (particular) request, generating by the resource node at least one busyness indication, the busyness indication based on a number of storage elements occupied in the buffer of the resource node.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. A data processing network comprising:
an integrated-circuit data processing apparatus; and
at least one external device, external to the integrated-circuit data processing apparatus;
the integrated-circuit data processing apparatus comprising:
an interconnect system;
at least one target device, the at least one target device coupled to the interconnect system; and
a requesting node, coupled to the interconnect system, the requesting node configured to receive requests from the at least one external device, and output the requests to a target device of the at least one target device via the interconnect system, thereby acting as a bridge for the at least one external device;
wherein the requesting node is configured to receive at least one busyness indication from at least one of the target devices, and, based on the received busyness indication(s), to throttle its outputting of requests received from the at least one external device to at least one of the at least one target devices via the interconnect system.

2. The data processing network of claim 1, wherein the requesting node is configured to throttle its outputting of write requests and read requests independently.

3. The data processing network of claim 1, comprising at least one target device of a first type, and at least one target device of a second type, wherein the requesting node is configured to throttle its outputting of requests to target devices of the first type and the second type independently.

4. The data processing network of claim 3, wherein the first type is local, on-chip target devices and the second type is remote, off-chip target devices.

5. The data processing network of claim 3, wherein the first type is a peer external device, and the second type is a memory device.

6. The data processing network of claim 1, comprising at least one external device of a first type, and at least one external device of a second type, wherein the requesting node is configured to throttle its outputting of requests received from external devices of the first type and the second type independently.

7. The data processing network of claim 6, wherein the first type are external devices having a first quality of service class and the second type are external devices having a second quality of service class, the second quality of service class being different to the first quality of service class.

8. The data processing network of claim 6, wherein the first type of external device is a device associated with a first device identifier, and the second type of external device is a device associated with a second device identifier.

9. The data processing network of claim 1, wherein the requesting node is configured to limit its number of outstanding requests to at least one of the target device(s) to an outstanding-request-threshold, and wherein the requesting node is configured to vary the outstanding-request-threshold based on the received busyness indication(s).

10. The data processing network of claim 9, wherein the received busyness indication(s) may be indicative of one of at least a first busyness level and a second busyness level, wherein the requesting node is configured to:
compare the number of first level busyness indications received in a sampling window to a first threshold, and if the number of first level busyness indications received in the sampling window exceeds the first threshold, to decrement the outstanding-request-threshold by a decrement value.

11. The data processing network of claim 10, wherein the requesting node is further configured to:
generate an overview busyness indication; and
based on the overview busyness indication indicating a low level of busyness, increment the outstanding-request-threshold by an increment value.

12. The data processing network of claim 11, wherein the increment value is lower than the decrement value.

13. The data processing network of claim 11, wherein the first threshold, the second threshold, the increment value, the decrement value and a magnitude of the sampling window are configurable.

14. The data processing network of claim 9, wherein the outstanding-request-threshold is a first outstanding-request-threshold, associated with a first request type, the requesting node further configured to limit its number of outstanding requests of a second request type to a second outstanding-request-threshold, the value of the first outstanding-request-threshold being independent of the value of the second outstanding-request-threshold.

15. The data processing system of claim 1, wherein the requesting node is configured to filter the busyness indications received from the at least one target device such that the number of busyness indications counted in response to a particular request is limited to a maximum of one.

16. A method of data processing, comprising:
receiving, by a requesting node of an integrated-circuit data processing apparatus of a data processing network, requests from at least one external device external to the integrated-circuit data processing apparatus, directed towards at least one target device coupled to an interconnect system;
outputting the requests to the target devices, thereby acting as a bridge for the at least one external device;
in response to the requests, receiving, by the requesting node, responses, the responses comprising at least one busyness indication from at least one of the target devices; and
based on the received busyness indication(s), the requesting node throttling its outputting of requests received from the at least one external device to at least one of the at least one target devices via the interconnect system.

17. The method of claim 16, comprising the requesting node throttling its outputting of requests based on at least one of the type of the target device for the request and/or the type of the external device issuing the request.

18. A non-transitory computer-readable medium storing computer-readable code for fabrication of the data processing network of claim 1.

19. A data processing network comprising:
an integrated-circuit data processing apparatus; and
at least one downstream resource, external to the integrated-circuit data processing apparatus;
the integrated-circuit data processing apparatus comprising:
an interconnect system;
at least one requesting node; and
a resource node, associated with the at least one downstream resource and coupled to the at least one requesting node via the interconnect system, wherein the resource node is configured to receive requests from a requesting node via the interconnect system directed towards the at least one downstream resource, thereby acting as a bridge for the at least one downstream resource;
the resource node comprising a buffer, for storing outstanding requests awaiting response from the at least one downstream resource, wherein the resource node is configured to generate at least one busyness indication responsive to a request from a requesting node, the busyness indication based on a number of storage elements occupied in the buffer of the resource node.

20. The data processing network of claim 19, wherein the resource node comprises a first buffer, associated with downstream resources of a first type, and a second buffer associated with downstream resources of a second, different type, and wherein the resource node is configured to generate a busyness indication in response to a request directed to a downstream resource of the first type based on a number of storage elements occupied in the first buffer.
